(19) United States
(12) Patent Application Publication
(10) Pub. No.: US 2006/0155895 A1
(43) Pub. Date: Jul. 13, 2006

(54) Data transferring apparatus and data transferring method

(75) Inventors: Shinnosuke Matsuda, Kawasaki (JP); Nina Arataki, Kawasaki (JP); Sadayuki Ohyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/089,350

(22) Filed: Mar. 25, 2005

(30) Foreign Application Priority Data
Dec. 10, 2004 (JP) 2004-358141

(51) Int. Cl. G06F 5/00

(52) U.S. Cl. 710/52

(57) ABSTRACT

A data transferring apparatus receives comparison data to be compared with stored data from an external unit, searches data corresponding to the comparison data from among the stored data, and transfers the data searched to the external unit. A control unit generates comparison-condition information for searching predetermined stored data from a data storing memory. A comparison-data storing unit stores the comparison data received. A comparison-condition storing unit stores the comparison-condition information generated, upon the comparison-data storing unit storing the comparison data. A transfer processing unit transfers the stored data searched to the external unit.

### BACKGROUND OF THE INVENTION

1) Field of the Invention

The present invention relates to a technology for searching data in a computer system and performing a direct-memory-access (DMA) transfer of the data.

2) Description of the Related Art

In recent years, there has been a rapid progress in development of a technology for improving a performance of computer systems. For example, an efficient transfer of data between memories in a computer system and between a memory and an I/O device has been sought after.

A DMA is one of the methods for an efficient transfer of data. In the DMA, instead of a central processing unit (CPU) that performs the data transfer in the computer system, a DMA circuit that is used as a dedicated hardware that performs the data transfer in the computer system based on a command from the CPU.

FIG. 11 is a block diagram of a structure of a conventional DMA chip. A DMA chip 100 is used in components such as a channel adapter in a disc array unit and includes a memory I/F unit 91 that is connected to a memory (storing a command from a micro processing unit (MPU) in the channel adapter) and a cache I/F unit 97 that is connected to a cache memory (storing data that is searched) on a disc array side.

A registering unit 99 receives instructions (commands) from the MPU in the channel adapter by register writing, provides a memory address and data length etc. as necessary information in a descriptor to a search-data reading unit 92, and provides a cache address and data length etc. as necessary information in the descriptor, to a key-count reading unit 95.

The search-data reading unit 92 reads search data from a comparison-data length from the memory address that is designated to a register and the key-count reading unit 95 reads data of a key unit or a count unit of the comparison-data length from the cache address that is designated to the register. The key-count reading unit 95, when receives search data from the cache memory via the cache I/F unit 97, reads search data from a buffer 93 of the search-data reading unit 92 and compares the respective search data. Then, the key-count reading unit 95 makes a judgment of whether a result of comparison satisfies (Hit) a comparing condition of the search data or not (Miss), as well as interrupts the MPU with each comparison (data search etc.).

FIG. 12 is a sequence diagram of a processing procedure for a conventional data search. Comparison data (comparison key) for performing search of data that is sent from a host computer 101 is stored in a memory 103 of the channel adapter. Data search is started upon setting by register a memory address, a cache address, and a mode etc. to the DMA chip 100 from the MPU 105 in the channel adapter.

The DMA chip 100 receives the search data (comparison key) respectively from the memory 103 and a cache memory 107 on the disc array side, based on the memory address and the cache address that are designated by the MPU 105, and then compares the respective search data.

When a result of comparison of the search data is “Miss”, the DMA chip 100 interrupts the MPU 105. Then, the MPU 105 once again performs register setting in the DMA chip 100 so that the DMA chip 100 performs the next comparison, and performs a key search (comparison of search data). The key search is performed repeatedly till the result of comparison of the search data is “Hit”. When the result of the comparison of the search data becomes “Hit”, the DMA chip 100 interrupts the MPU 105 and stops comparison of data by the DMA chip 100.

Thus, in a search operation by the conventional DMA chip 100, if the comparison of the search data does not match with the comparison condition by comparing once, the MPU 105 is required to give instructions to the DMA chip 100 for the next comparison of the search data.

However, sometimes a transmission speed of a bus (data-transmission path) that receives data from a host computer in the DMA chip differs from a transmission speed of a bus that receives data from the cache memory.

FIG. 13 is a block diagram of a structure of a conventional protocol DMA chip. A protocol DMA chip 150 has a function of a protocol chip that controls a protocol in a communication with a host computer (not shown) and a function of a DMA chip that includes the DMA circuit.

The protocol DMA chip 150 includes a host (personal computer) I/F unit 156, a protocol control unit 160, a cache I/F 157, and a memory I/F 151. The host I/F unit 156 is connected to the host computer. The protocol control unit 160 includes a buffer 161 that stores temporarily search data from the host computer (MPU in the channel adapter). The cache I/F unit 157 is connected to a cache memory on the disc array side.

In the protocol DMA chip 150 shown in FIG. 13, the search data (such as memory address and data length) from the host computer is transmitted to a search-data reading unit 152 without being passed through a registering unit 159. A comparison unit 58 compares search data stored by the search-data reading unit 152 and search data (key) that is transmitted via a key-count reading unit 155 from the cache memory.

In the protocol DMA chip 150, key etc. from the cache memory cannot be read till all the search data stored in the buffer 161 in the protocol control unit 160 is stored in a buffer 153 in the search-data reading unit 152.

While comparing the data, it is necessary that the next transmission (data reception) is performed after a bus with a high transmission-speed of data (such as a peripheral-component-interconnect (PCI) bus that connects the cache I/F unit 157 and the key-count reading unit 155), waits for a processing by a bus with a low transmission-speed of data (such as a bus that connects the protocol control unit 160 and the search-data reading unit 152), which affects an efficiency of data transfer.

An asynchronous file controlling unit that has been disclosed in Japanese Patent Application Laid-open Publication No. H5-165725, performs a cache control by a cache mechanism and an asynchronous file control of a device. The asynchronous file controlling unit includes a buffer for data transfer that stores temporarily transfer data and a comparison circuit that compares the transfer data. A register that can supply from the buffer for data transfer data to the comparing circuit independently apart from a normal route of data transfer is provided. A data transfer to the normal route of data transfer is performed as well during a comparison operation by the comparing circuit.

However, according to the conventional technology, if the comparison of the search data does not match with comparison conditions, the search data cannot be compared by suppressing an overhead of the MPU.

### SUMMARY OF THE INVENTION

It is an object of the present invention to solve at least the above problems in the conventional technology.

A data transferring apparatus according to one aspect of the present invention, which is connected to a data storing memory that stores a plurality of data as a plurality of stored data, and which receives comparison data to be compared with the stored data from an external unit, searches data corresponding to the comparison data from among the stored data, and transfers the stored data searched to the external unit, includes a control unit that controls the entire data transferring apparatus, and generates a plurality of pieces of comparison-condition information for searching predetermined stored data from the data storing memory; a comparison-data storing unit that stores the comparison data received; a comparison-condition storing unit that stores the comparison-condition information generated, upon the comparison-data storing unit storing the comparison data; and a transfer processing unit that transfers the stored data searched to the external unit. The transfer processing unit includes an information extracting function of reading the comparison-condition information stored one by one, and extracting, from the comparison-condition information read, comparison-data reading information for reading the comparison data from the comparison-data storing unit and stored-data reading information for reading the stored data from the data storing memory; a comparison-data reading function of reading the comparison data from the comparison-data storing unit based on the comparison-data reading information extracted; a stored-data reading function of reading the stored data from the data storing memory based on the stored-data reading information extracted; and a stored-data searching function of searching the stored data corresponding to the comparison-condition information and the comparison data by comparing the stored data read with the comparison data read based on the comparison-condition information.

A data transferring apparatus according to another aspect of the present invention, which is connected to a data storing memory that stores a plurality of data as a plurality of stored data, and which receives comparison data to be compared with the stored data from an external unit, searches data corresponding to the comparison data from among the stored data, and transfers the stored data searched to the external unit, includes a comparison-data storing unit that stores the comparison data received; a control unit that controls the entire data transferring apparatus, and generates comparison-condition information for comparing the stored data with the comparison data; a transfer processing unit that transfers the stored data searched to the external unit. The transfer processing unit includes a comparison-data reading function of reading the comparison data from the comparison-data storing unit based on the comparison-data reading information; a stored-data reading function of reading the stored data from the data storing memory based on the comparison-condition information; and a stored-data searching function of searching the stored data corresponding to the comparison-condition information and the comparison data by comparing the stored data read with the comparison data read based on the comparison-condition information. The comparison-data reading function includes a comparison-data storing buffer that reads the comparison data from the comparison-data storing unit, temporarily stores the comparison data read, and when the comparison data temporarily stored is read by the stored-data searching function, reads next comparison data from the comparison-data storing unit, and temporarily stores the next comparison data read. The stored-data reading function includes a stored-data storing buffer that reads the stored data from the stored-data storing unit, temporarily stores the stored data read, and when the stored data temporarily stored is read by the stored-data searching function, reads next stored data from the stored-data storing unit, and temporarily stores the next stored data read.

A data transferring method according to still another aspect of the present invention, which is for a data transferring apparatus that is connected to a data storing memory that stores a plurality of data as a plurality of stored data, that receives comparison data to be compared with the stored data from an external unit, that searches data corresponding to the comparison data from among the stored data, and that transfers the stored data searched to the external unit, includes generating a plurality of pieces of comparison-condition information for searching predetermined stored data from the data storing memory; storing the comparison data received in a first memory; storing the comparison-condition information in a second memory upon the comparison data being stored in the first memory; reading the comparison-condition information stored in the second memory one by one; extracting comparison-data reading information for reading the comparison data from the first memory and stored-data reading information for reading the stored data from the data storing memory from the comparison-condition information; reading the comparison data from the first memory based on the comparison-data reading information; reading the stored data from the data storing memory based on the stored-data reading information; searching the stored data corresponding to the comparison-condition information and the comparison data by comparing the stored data read with the comparison data read based on the comparison-condition information; and transferring the stored data searched to the external unit.

A data transferring method according to still another aspect of the present invention, which is for a data transferring apparatus that is connected to a data storing memory that stores a plurality of data as a plurality of stored data, that receives comparison data to be compared with the stored data from an external unit, that searches data corresponding to the comparison data from among the stored data, and that transfers the stored data searched to the external unit, includes storing the comparison data received in a comparison-data storing memory; generating comparison-condition information for comparing the stored data with the comparison data; reading the comparison data from a comparison-data memory based on the comparison-data reading information; reading the stored data from the data storing memory based on the comparison-condition information; searching the stored data corresponding to the comparison-condition information and the comparison data by comparing the stored data read with the comparison data read based on the comparison-condition information; and transferring the stored data searched to the external unit. The reading the comparison-data includes reading the comparison data from the comparison-data memory; storing temporarily the comparison data read in a first buffer; reading, when the comparison data temporarily stored is read, next comparison data from the comparison-data memory; and storing temporarily the next comparison data read in the first buffer. The reading the stored data includes reading the stored data from the stored-data memory; storing temporarily the stored data read in a second buffer; reading, when the stored data temporarily stored is read, next stored data from the stored-data memory; and storing temporarily the next stored data read in the second buffer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an illustration for describing a concept of a DMA control according to a first embodiment of the present invention;

FIG. 2 is a block diagram of a configuration of a disc array according to the first embodiment;

FIG. 3 is a block diagram of an example of a configuration of a channel adapter according to the first embodiment;

FIG. 4 is a block diagram of a configuration of a DMA chip according to the first embodiment;

FIG. 5 is a sequence diagram of a processing procedure for a data search of the channel adapter;

FIG. 6 is a diagram of a configuration of a CKD (Count, Key, Data) format;

FIG. 7 is a diagram of an example of a configuration of a descriptor;

FIG. 8 is a state-transition diagram of a state-transition of a state machine of the DMA chip;

FIG. 9 is a block diagram of an example of a configuration of a channel adapter according to a second embodiment of the present invention;

FIG. 10 is a block diagram of an example of a configuration of a protocol DMA chip according to the second embodiment;

FIG. 11 is a block diagram of a configuration of a conventional DMA chip;

FIG. 12 is a sequence diagram of a processing procedure of a conventional data search; and

FIG. 13 is a block diagram of a configuration of a conventional protocol DMA chip.

### DETAILED DESCRIPTION

Exemplary embodiments of a data transferring apparatus and a data transferring method according to the present invention are explained in detail below with reference to the accompanying drawings. However, the present invention is not restricted to these embodiments.

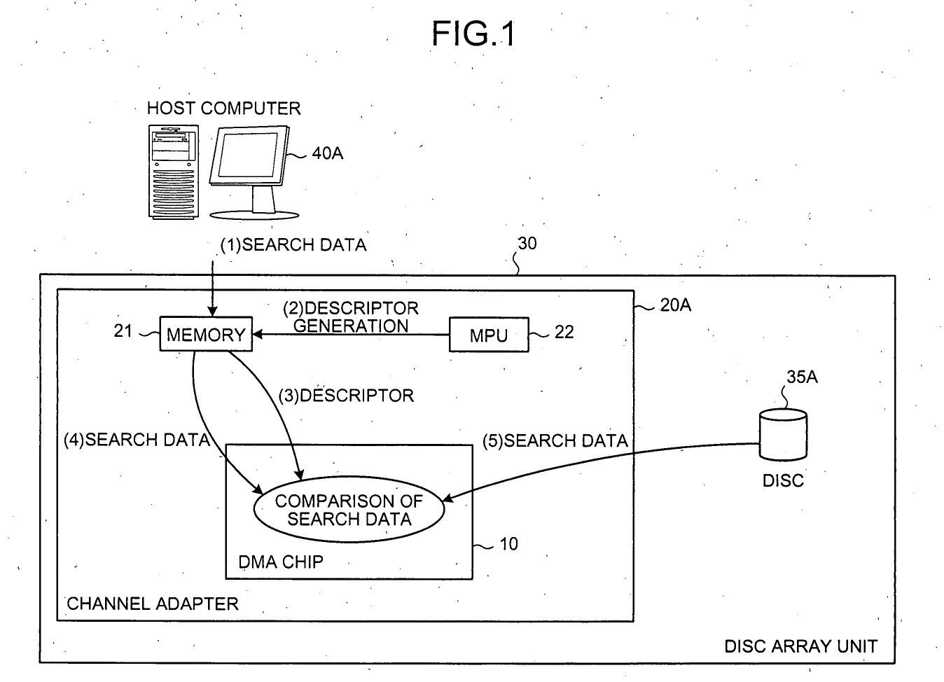

FIG. 1 is an illustration for describing the concept of the DMA control. A disc array unit 30 performs search of data in the disc array unit 30, based on instruction-information that is transmitted from a host computer (external unit) 40A, and provides data that is searched to the host computer 40A.

According to a first embodiment of the present invention, search data for data search that is transmitted from the host computer 40A is stored in a memory 21 of a channel adapter (data transferring apparatus) 20A. MPU 22 generates a plurality of requests as a descriptor (information of conditions for comparison for performing data search) in the memory 21. A DMA chip 10 that transfers DMA in the channel adapter 20A reads descriptors (a series of information) in the memory 21 one by one, and based on the descriptors read, compares the search data (comparison data) in the memory 21 and search data from a disc 35A. Data that is searched by the DMA chip 10 is transferred to the host computer 40A.

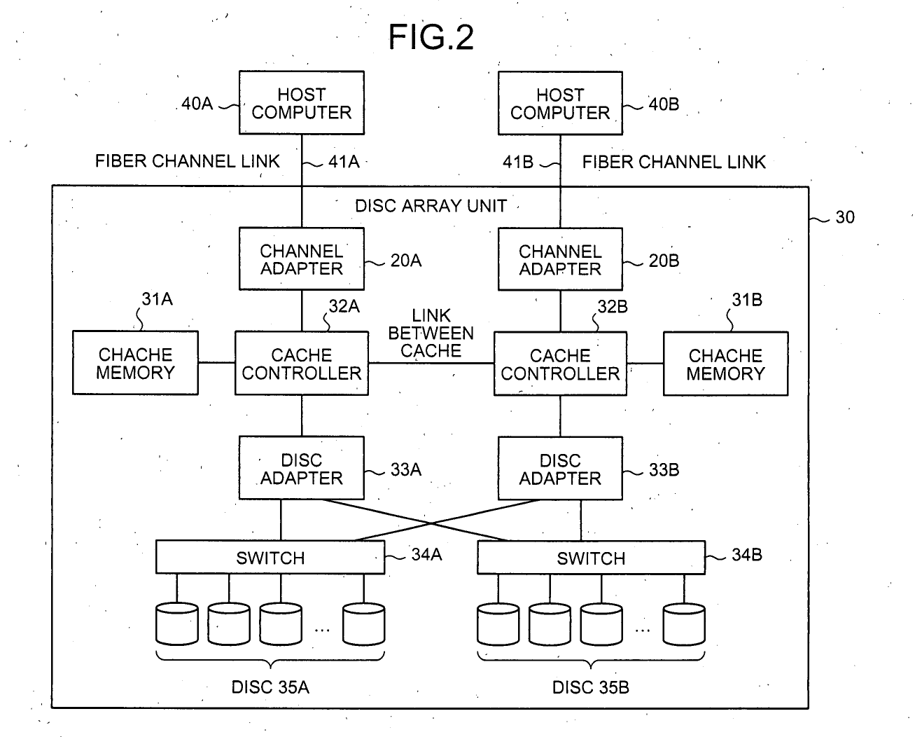

FIG. 2 is a block diagram of a configuration of a disc array unit according to the first embodiment. The disc array unit 30 is an example of a computer system in which a DMA (DMA chip 10 that is described later) that includes a DMA control circuit is used. The disc array unit 30 is connected to the host computer 40A and a host computer 40B. The disc array unit 30 is a unit such as a personal computer that searches data in the disc array unit 30 based on instruction-information that is transmitted from the host computers 40A and 40B, and provides the data searched to the host computers 40A and 40B.

The disc array unit 30 has a redundant-arrays-of-independent-disks (RAID) for writing at a high speed a large amount of data, by combining a plurality of discs (data storing memory) 35A and 35B.

The disc array unit 30 includes channel adapters 20A and 20B, cache memories 31A and 31B, cache control units 32A and 32B, disc adapters 33A and 33B, switches 34A and 34B, and discs 35A and 35B.

Since each of the channel adapters 20A and 20B have similar functions, each of the cache memories 31A and 31B have similar functions, each of the cache control units 32A and 32B have similar functions, each of the disc adapters 33A and 33B have similar functions, each of the switches 34A and 34B have similar functions, and each of the discs 35A and 35B have similar functions, the channel adapter 20A, the cache memory 31A, the cache control unit 32A, the disc adapter 33A, the switch 34A and the disc 35A are described below.

The channel adapter 20A has a function of a communication interface that transmits and receives data to and from the host computer 40A, and includes the DMA chip 10 that transfers the DMA. The cache memory 31A stores temporarily data of the disc 35A that stores a plurality of data. The cache control unit 32A performs management and control of the cache memory 31A. The disc adapter 33A has a communication interface that transmits and receives data to and from the disc 35A. The switch 34A connects the plurality of discs 35A and switches a connection of each disc and the disc adapter 33A. The disc 35A includes a plurality of discs and is controlled by a disc drive (not shown in the diagram). The disc 35A stores a plurality of data that is subjected to transfer (search).

When the channel adapter 20A receives a request for reading data from the host computer 40A, it checks if a predetermined data specified by the host computer 40A exists in the cache memory 31A.

If the data specified by the host computer is there in the cache memory 31A, the cache memory 31A notifies the channel adapter 20A a possibility of reading the data. The channel adapter 20A reads the data that can be read from the cache memory 31 and transfers it to the host computer 40A.

On the other hand, if the data specified by the host computer 40A is not there in the cache memory 31A, the cache memory 31A reads data from the disc 35A that stores the predetermined data specified by the host computer via the disc adapter 33A and the switch 34A, and stores (staging) it in the cache memory 31A. After this, the cache memory 31A notifies the channel adapter 20A of a possibility of reading the data. The channel adapter 20A reads the data that can be read from the cache memory 31A and stores it in the host computer 40A. Thus, since the disc array unit 30 is provided with the cache memory 31A, an access time of data from the channel adapter 20A can be shortened.

The host computer is not restricted to a combination of two host computers 40A and 40B and may be one host computer or a combination of more than two host computers. Moreover, the configuration of the disc array unit 30 is not restricted to the configuration that includes two channel adapters and may be a configuration that includes one channel adapter or more than two channel adapters.

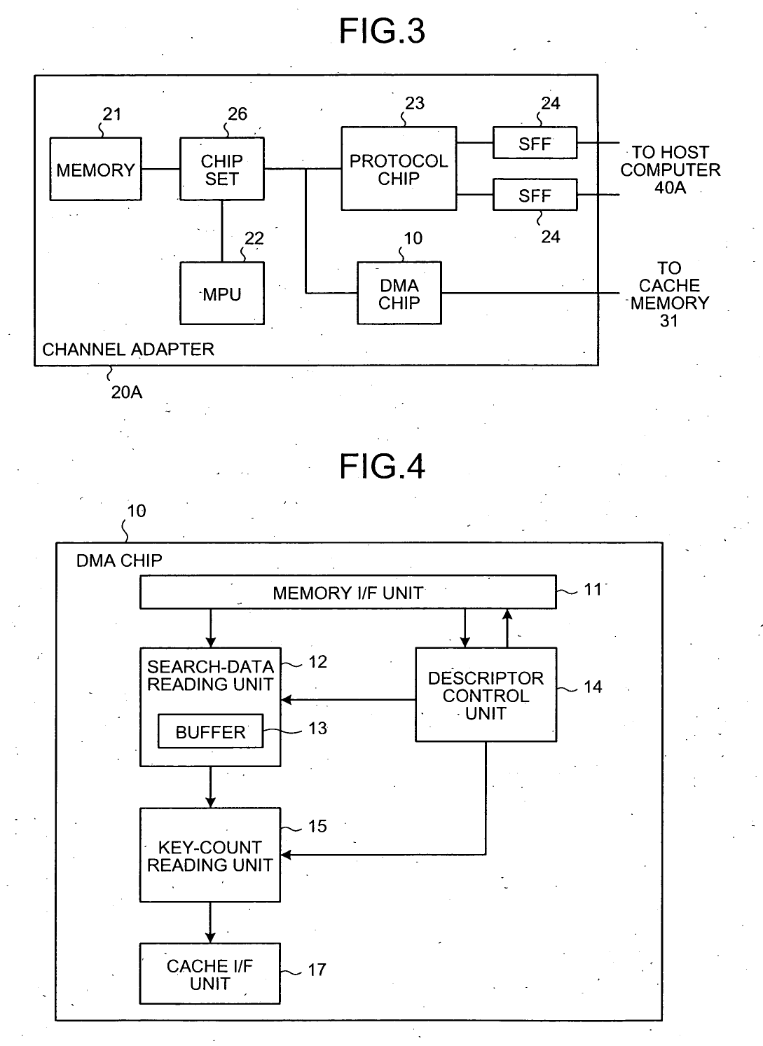

FIG. 3 is a block diagram of an example of a configuration of a channel adapter according to the first embodiment. The channel adapter 20A includes a memory 21, an MPU (control unit) 22, a chip set 26, a protocol chip 23, a small form factor (SFF) 24, and the DMA chip (transfer processing unit) 10. The memory 21 is a comparison-data storing unit (first memory, comparison-data memory), comparison-condition storing unit (second memory).

The protocol chip 23 is a large-scale integrated-circuit (LSI) for controlling a protocol of a fiber channel (fiber channel link 41A) that is used in connection with the host computer 40A. The disc array unit 30 and the host computer 40A are connected by connecting the protocol chip 23 and the host computer 40 by an optical cable. The SFF 24 is a module that performs electro-optical conversion.

The MPU 22 is a processor (LSI) that controls the channel adapter 20A and the chip set 26 is a memory interface (LSI) that is connected to the memory 21. The memory 21 includes a dynamic random-access-memory (DRAM) and stores a descriptor from the MPU 22 (command to the DMA chip 10 from the MPU 22) and searches data from the host computer 40A.

The DMA chip 10 has a DMA function (DMA circuit) and an interface function of communicating with the cache memory 31A. The DMA chip 10 performs communication between the DMA chip 10 and the cache memory 31A according to instruction-information transmitted from the MPU 22. According to the first embodiment, the DMA chip 10 transfers data based on the descriptor that is transmitted from the MPU 22 to the memory 21 and stored in the memory 21.

The MPU 22, the chip set 26, the protocol chip 23, and the DMA chip 10 are connected mutually by a PCI bus and transfers data mutually. Instructions from the MPU 22 to the protocol chip 23 and the DMA chip 10 are given by the PCI bus.

When the channel adapter 20A receives search data from the host computer 40A via the fiber channel link 41A, it stores the search data received in the memory 21. The MPU 22 transmits a predetermined descriptor to the memory 21 and the memory 21 stores the descriptor from the MPU 22. The DMA chip 10 reads the descriptors in the memory 21 one by one and compares the search data stored in the memory 21 and the search data (stored in the cache memory 31A (a count unit or a key unit in a record that is described later). In other words, the DMA chip 10 reads search data from the memory 21 and the cache memory 31A respectively and compares these search data.

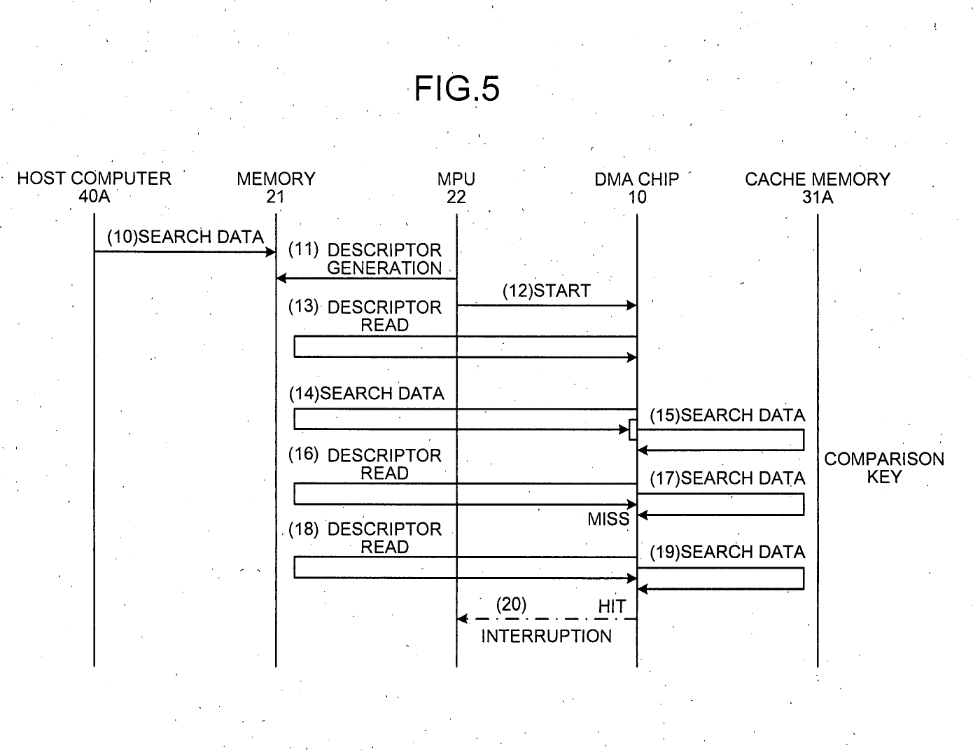

The following is a description of the DMA chip 10. FIG. 4 is a block diagram of a configuration of the DMA chip according to the first embodiment. The DMA chip 10 includes a memory I/F unit (memory I/F block) 11, a search-data reading unit (search-data reading block) 12, a key-count reading unit (key-count reading block) 15, a descriptor control unit (descriptor block) 14, and a cache I/F unit (cache I/F block) 17.

The memory I/F unit 11 has a communication interface that connects to the memory 21, and performs a protocol control of this communication interface. The memory I/F unit 11 receives predetermined data from the memory 21 by controlling the communication interface (outputting a request for the communication interface).

The cache I/F unit 17 has a communication interface that connects to the cache memory 31A and performs the protocol control of this communication interface. The cache I/F unit 17 receives predetermined data from the memory 31A by controlling the communication interface.

According to the first embodiment, the communication interface of the memory I/F unit 11, and the cache I/F unit 17 is a PCI bus and each PCI bus includes respective PCI bus protocol control circuit.

The descriptor control unit (information extracting function) 14 receives instructions (instruction information) from the MPU 22 and reads one by one the descriptors stored in the memory 21. The descriptor control unit 14 extracts predetermined information (address, data length, and mode) (comparison-data reading information and stored-data reading information) from the descriptor that is read from the memory 21 and transmits it to the search-data reading unit 12 and the key-count reading unit 15. The address includes a cache address (comparison-data address) of the cache memory 31A and a memory data search by the channel adapter. Search data for searching the data that is transmitted from the host computer 40A is stored in the memory 21 in the channel adapter 20A (10). When the search data from the host computer 40A is stored in the memory 21, the MPU 22 generates (stores) a descriptor in the memory 21 (11) and activates the DMA chip 10 (12).

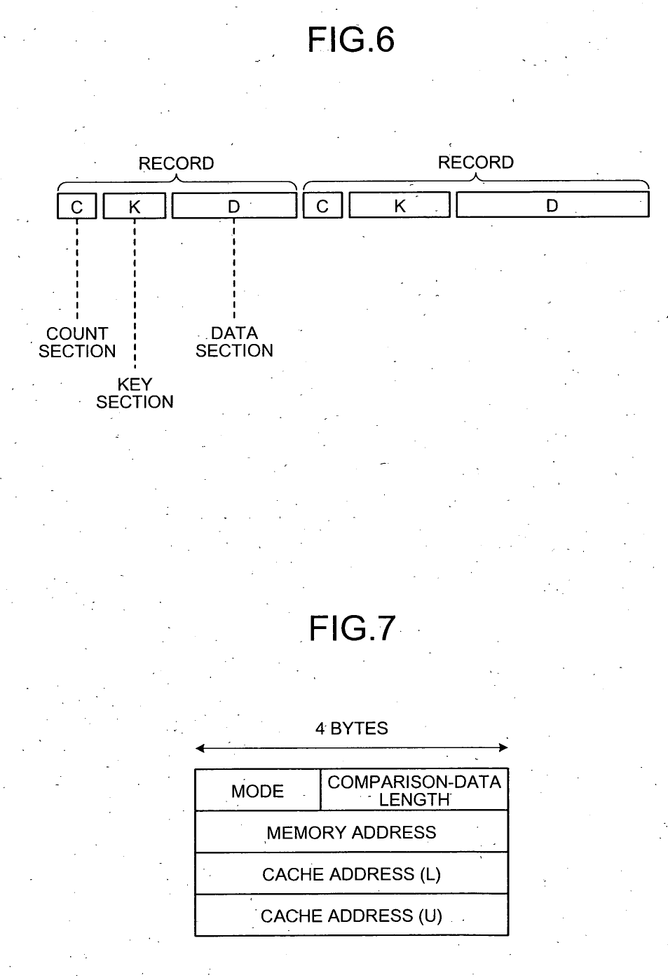

A configuration of a descriptor and a data format in the disc array unit 30 is described below. A data format such as a CKD format is used in the disc array unit 30. FIG. 6 is a diagram of a configuration of the CKD format. Data in the disc array unit 30 is written in the discs 35A and 35B, and cache memories 31A and 31B in units of records according to the CKD format (variable-length data format). Each record includes a count unit (C), a key unit (K), and a data unit (D) among which the count unit has a fixed length and the key unit and the data unit have variable length.

The count unit includes information about an address and a data length of record that is recorded. The key unit is information (such as index) that an OS (Operating System) uses for identifying the record. The data unit is information that indicates area in which user data is stored.

FIG. 7 is a diagram of an example of a configuration of the descriptor. A plurality of descriptors are generated in the memory 21 by the MPU 22 and each descriptor includes fields viz. “mode”, “comparison-data length”, “memory address”, and “cache address”. The “mode” is a field for controlling an operation of the DMA chip 10 and includes the following contents (information).
(1) Information of whether or not the MPU 22 performs interruption when the comparison result of the search data satisfies the conditions for comparison. When this field is “0”, no interruption is performed and when this field is “1” interruption is performed. According to the first embodiment, the mode is set to “1” for example.
(2) Comparison mode (information of as to when the comparison condition is fulfilled). When this field is “00”, if the search data and the key unit (or count unit) are equivalent, the comparison condition is judged to be fulfilled. When this field is “01”, if the key unit is greater than or equivalent to the search data, the comparison condition is judged to be fulfilled. When this field is “1X”, if the key unit is greater than the search data, the comparison condition is judged to be fulfilled.
(3) Information of whether new search data is read from the memory and used or not. When this field is “0”, search data that is used in the immediately preceding descriptor is used as it is and when this field is “1”, new search data is read from the memory 21 and used. This bit may be set to “1” for a first descriptor and to “0” for remaining descriptors.

The “comparison-data length” denotes byte length of the search data and the key unit or the count unit (data block for comparison). In the CKD format, since the count unit is always 8 bytes (fixed) and the key unit has a variable length from 1 byte to 255 bytes, the “comparison-data length” is a field of 8 bits so that the byte length of 1 byte to 255 bytes can be designated.

The “memory address” is an address on the memory 21 of the search data that is prepared by the MPU 22 for the DMA chip 10, and is designated by a field of 32 bits. The “cache address” is an address of the key unit or the count unit in the record on the cache memory 31A, and is designated by a field of 64 bits. The “cache address” is designated by a cache address such as a “cache address (U)” for designating upper 4 bytes on the cache memory 31A and a “cache address (L)” for designating lower 4 bytes on the cache memory 31A.

The DMA chip 10 reads a descriptor that is generated in the memory 21 (13). The DMA chip 10 reads search data from the memory 21 based on the “memory address” designated by the descriptor (14). The DMA chip 10 reads search data from the cache memory 31A of the disc array unit 30 based on the “cache address” designated by the descriptor (15).

The descriptor control unit 14 of the DMAchip 10 receives instructions from the MPU 22 and reads the descriptor stored in the memory 21. The descriptor control unit 14 extracts predetermined information (address, data-length, and mode) from the descriptor that is read and transmits it to the search-data reading unit 12 and the key-count reading unit 15.

The search-data reading unit 12 reads search data of the comparison-data length from the memory 21 based on the memory address designated by the descriptor and stores the search data that is read, in the buffer 13.

The key-count reading unit 15 reads data (search data) of the key unit or the count unit of the comparison-data length from the cache memory 31A based on the cache address designated by the descriptor. When the key-count reading unit 15 receives the data (search data) from the cache memory 31A via the cache I/F unit 17, it reads the search data from the buffer 13 of the search-data reading unit 12. The key-count reading unit 15 compares the search data from the cache memory 31A and the search data (key unit or count unit) from the search-data reading unit 12 by comparison logic. The key-count reading unit 15 makes a judgment of whether a result of the comparison satisfies (Hit) the comparison condition or not (Miss), and notifies the judgment to the descriptor control unit 14.

If the result of comparison of the search data by the DMA chip 10 is “Miss”, the DMA chip 10 reads a next new descriptor from the memory 21 (16). Then, the DMA chip 10 reads new search data from the cache memory 31A based on a “cache address” that is designated by the new descriptor (17).

The DMA chip 10 compares the search data from the memory 21 and the new search data from the cache memory 31A by comparison logic, and repeats steps similar to (16) and (17) till a result of the comparison is “Hit” ((18), (19)). In other words, the DMA chip 10 performs comparison of the search data from the memory 21 with a count unit or a key unit of each record on the cache memory 31A till the comparison condition is satisfied.

The DMA chip 10 compares according to the descriptor of the memory 21 the search data and the count unit or the key unit one by one for a plurality of records till a predetermined search condition is satisfied. At this time, since the DMA chip 10 (channel adapter 20A) cannot make a direct access to the disc 35A, an operation of searching a record on the disc 35A is replaced with a search operation of a record that is staged in the cache memory 31A.

When a value of the search data of the buffer is equivalent to a value of the data (key unit) from the cache memory 31A, if the value of the key data is greater than the value of the search data, the comparison of the search data by the DMA chip 10 (key-count reading unit 15) is judged to satisfy (Hit) the comparison condition. When the DMA chip 10 (descriptor control unit 14) makes a judgment of the result of comparison of the search data to be “Hit” (data corresponding to search data from the descriptor and the host computer 40A), an interruption to MPU 22 is performed (20).

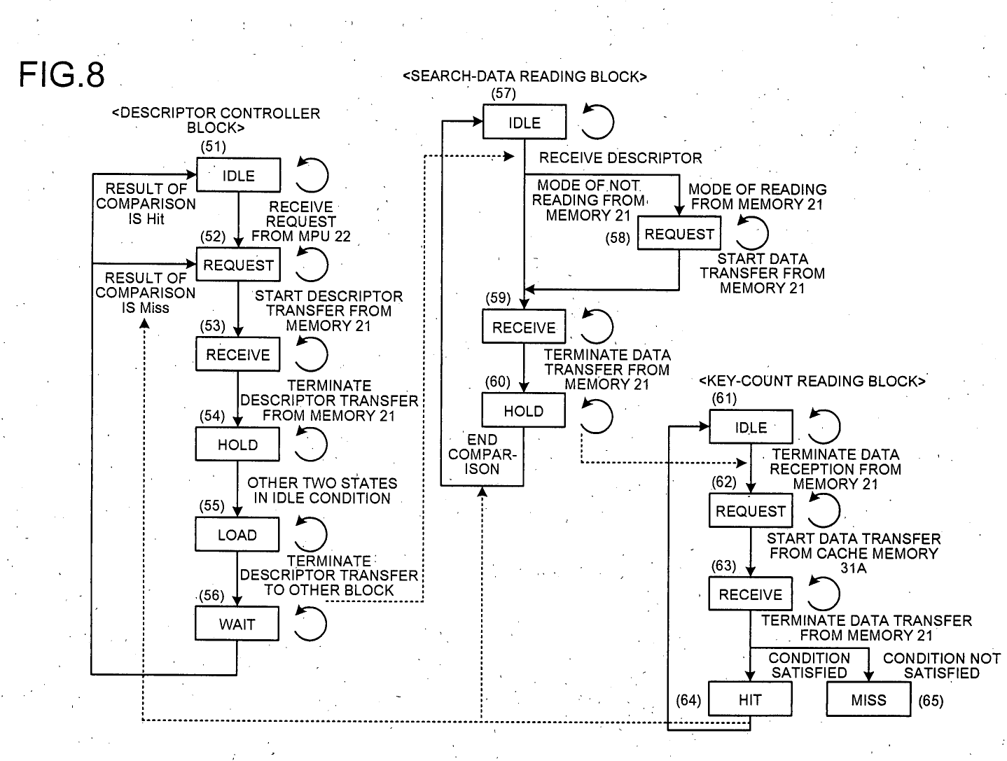

FIG. 8 is a state-transition diagram of a state-transition of the DMA chip 10. In the DMA chip 10, an operation of the DMA chip 10 is controlled while there is a mutual communication among each control block of the descriptor control unit 14, the search-data reading unit 12, and the key-count reading unit 15.

If the descriptor control unit 14 receives a request for data check from the MPU 22 while in an “Idle” state (51), the state changes to a “Request” state (52) (undergoes transition). In the “Request” state (52), when a transfer of a descriptor from the memory 21 to the descriptor control unit 14 starts, the descriptor control unit 14 goes in a “Receive” state (53).

When the transfer of the descriptor in the “Receive” state is terminated, the descriptor control unit 14 goes in a “Hold” state (54).

When the descriptor control unit 14 is in the “Hold” state, if a state of the search-data reading unit 12 and of the key-count reading unit 15 is the “Idle” state, the descriptor control unit 14 goes in a “Load” step (55).

The descriptor control unit 14 transfers the descriptor to the search-data reading unit 12 and the key-count reading unit 15 in the “Load” state and when the transfer is terminated, the descriptor control unit 14 goes in a “Wait” state.

A state-transition from the “Wait” state (56) depends on states (states (64), (65) described later) of the key-count reading unit 15 of the descriptor control unit 14. In other words, when the descriptor control unit 14 is in the “Wait” state (56), if a state of the key-count reading unit is that when it is judged to be “Hit”, the descriptor control unit 14 goes in “Idle” state (51). After this, the descriptor control unit 14 receives a new request from the MPU 22. Whereas, when the descriptor control unit 14 is in the “Wait” state (56), if the state of the key-count reading unit is that when it is judged to be “Miss”, the descriptor control unit 14 goes in the “Request” state (52). After this, the descriptor control unit 14 receives a next new descriptor from the memory 21 and once again starts the state-transition.

The search-data reading unit 12 undergoes a state-transition from an “Idle” state (57) to a next state with a condition of the “mode” of a descriptor received from the descriptor control unit 14. In other words, the search-data reading unit 12 while in the “Idle” state (57), receives the descriptor from the descriptor control unit 14 and if a setting of whether new search data is to be read from the memory 21 in the “mode” of the descriptor or not, is “1” (setting for reading), the search-data reading unit 12 goes to a “Request” state (58).

On the other hand, the search-data reading unit 12 while in the “Idle” state (57), receives the descriptor from the descriptor control unit 14, and if the setting of whether the new search data is to be read from the memory 21 in the “mode” of the descriptor or not, is “0” (setting for not reading), the search-data reading unit 12 goes in a “Receive” state (59).

When a data transfer from the memory 21 starts while the search-data reading unit 12 is in the “Request” state (58), the search-data reading unit 12 goes in the “Receive” state (59). The data transfer from the memory 21 ends when the search-data reading unit 12 is in the “Receive” state, or when the setting is for not reading the new search data from the memory in the “mode” of the descriptor, the search-data reading unit goes in a “Hold” state (60).

The “Hold” state of the search-data reading unit 12 undergoes transition to the “Idle” state (57) when the judgment of whether “Hit” (64) or “Miss” (65) is made in the key-count reading unit 15.

When the key-count reading unit 15 terminates receiving the search data from the memory while in an “Idle” state (61), the key-count reading unit 15 goes in a “Request” state (62).

If a data transfer from the cache memory 31 starts while the key-count reading unit 15 is in the “Request” state, the key-count reading unit 15 goes in a “Receive” state (63). If the data transfer from the cache memory 31A ends while the key-count reading unit 15 is in the “Receive” state (63), the data is compared (comparison of data by comparison logic). Further, in the key-count reading unit 15, when a judgment of whether a result of the comparison satisfies the comparison condition, is made, the key-counter reading unit 15 goes in a state such that the judgment is “Hit” (64). On the other hand, in the key-count reading unit 15, if the result of comparison is judged not to have satisfied the comparison condition, the key-counter reading unit 15 goes in a state such that the judgment is “Miss” (65). After an end of comparison of the data by the key-count unit 15, the search-data reading unit 12 and the descriptor control 14 undergo transition to the next state.

According to the first embodiment, in a case of the “Hit” during the comparison of the search-data by the key-count reading unit 15, data check is let to be completed and the interruption to the MPU 22 from the DMA chip 10 is performed. However, an arrangement may be made such that in a case of “Miss” during the comparison of the search data by the key-count reading unit 15, the data check is let to be completed and the interruption to the MPU 22 from the DMA chip 10 is performed.

Moreover, a descriptor is generated in the memory of the channel adapter. However, an arrangement may be made such that the descriptor is generated in a predetermined storage unit in the DMA chip 10.

Furthermore, since the memory 21 of the channel adapter is let to store the search data from the descriptor and the host computer 40A, a configuration may be allowed to be such that the search data from the descriptor and the host computer 40A is stored by a different storage unit.

Thus, since the DMA chip 10 includes the descriptor control unit 14, and the MPU 22 generates a descriptor in the memory 21, while comparing a set of search data, every time it is not necessary for the MPU 22 to generate and transmit information for comparing the key unit or the count unit of each field. Therefore, once the MPU 22 makes a request for data search to the DMA 10 chip, it is possible to continue the data search based on the descriptor that is generated in the memory 21 by the DMA chip 10.

Thus, according to the first embodiment, it is possible to reduce a load on the MPU 22 during the data search and the DMA chip 10 can perform the data search while the MPU 22 performs other process. This enables to speed-up the data search and to improve an efficiency of the data transfer.

### SECOND EMBODIMENT

According to a second embodiment, reading the search data from the host computer 40A and reading the key unit or the count unit from the cache memory 31A are started simultaneously, and when the search data stored in the buffer is caused to be read by a comparison unit 54, the key-count reading unit reads a next search data.

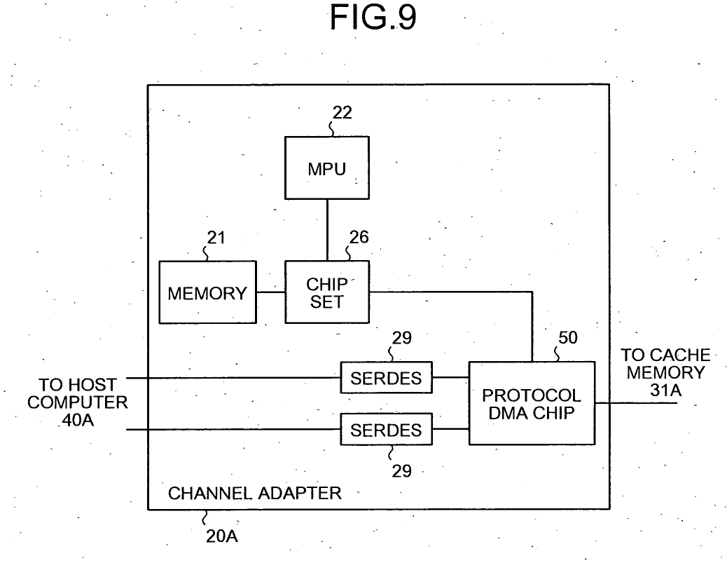

FIG. 9 is a block diagram of an example of a configuration of a channel adapter according to the second embodiment. The same reference numerals are used for components in FIG. 9 that have the same function as the components in the channel adapter 20A in the first embodiment shown in FIG. 3 and repeated description is avoided by omitting that description. In this case, the memory 21 is a comparison-data storing unit.

The channel adapter according to the second embodiment includes the memory 21, the MPU 22, the chip set 26, a serdes (serializer/deserializer) 29, and a protocol DMA chip 50. The serdes 29 is a device that converts parallel data to serial data and vice versa.

The protocol DMA chip (transferring unit) 50 has a function of the protocol chip 23 and the DMA chip 10. The protocol DMA chip 50 is connected to the cache memory 31A by a bus such as the PCI bus and a PCI-X bus, as well as is connected to the host computer 40A via the serdes 29.

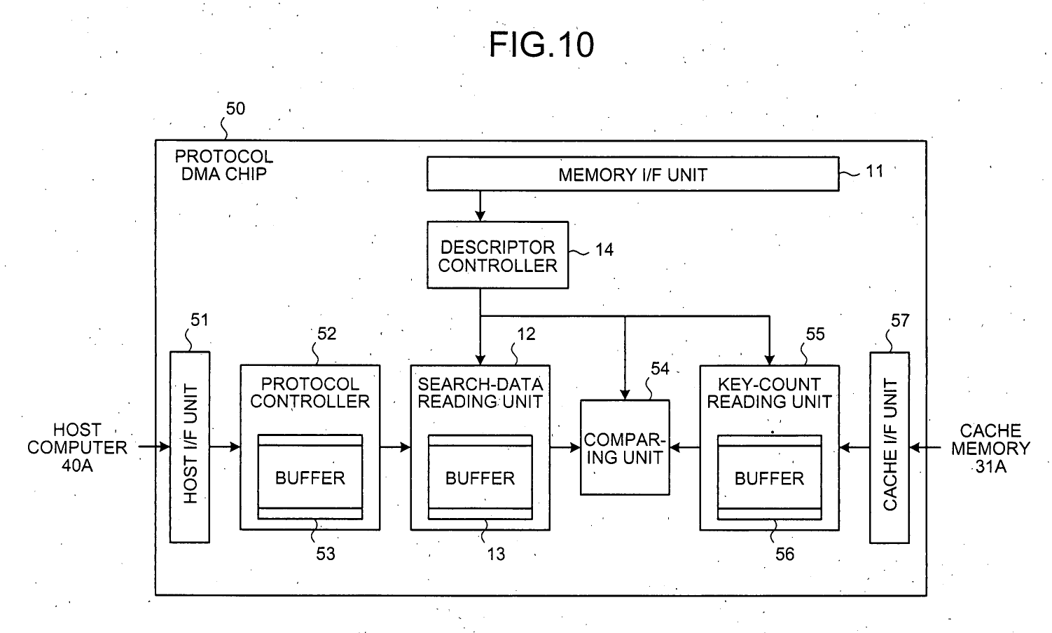

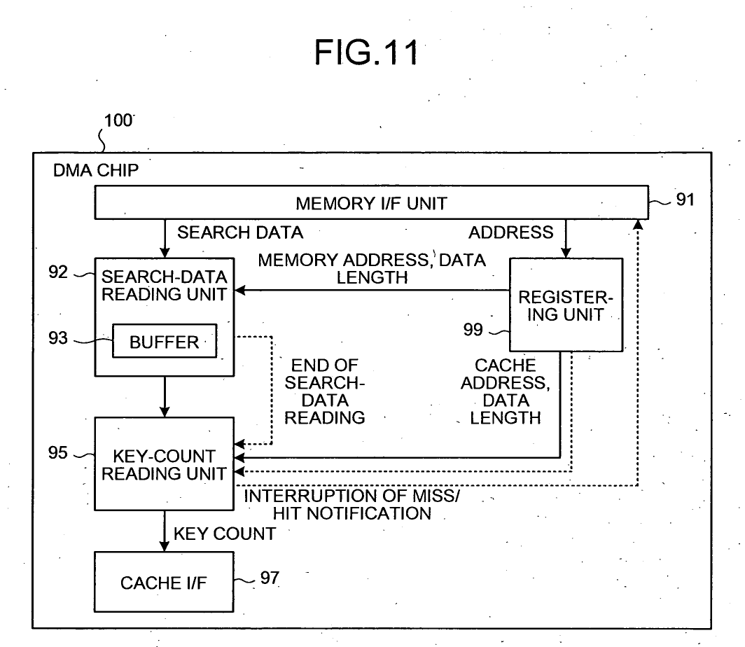

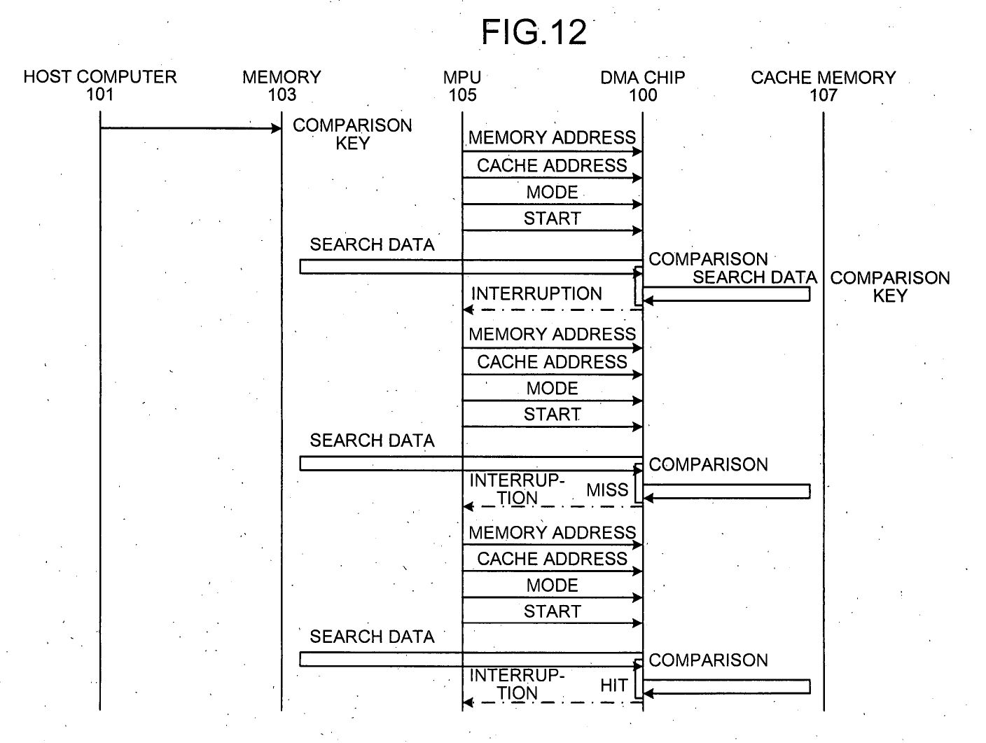

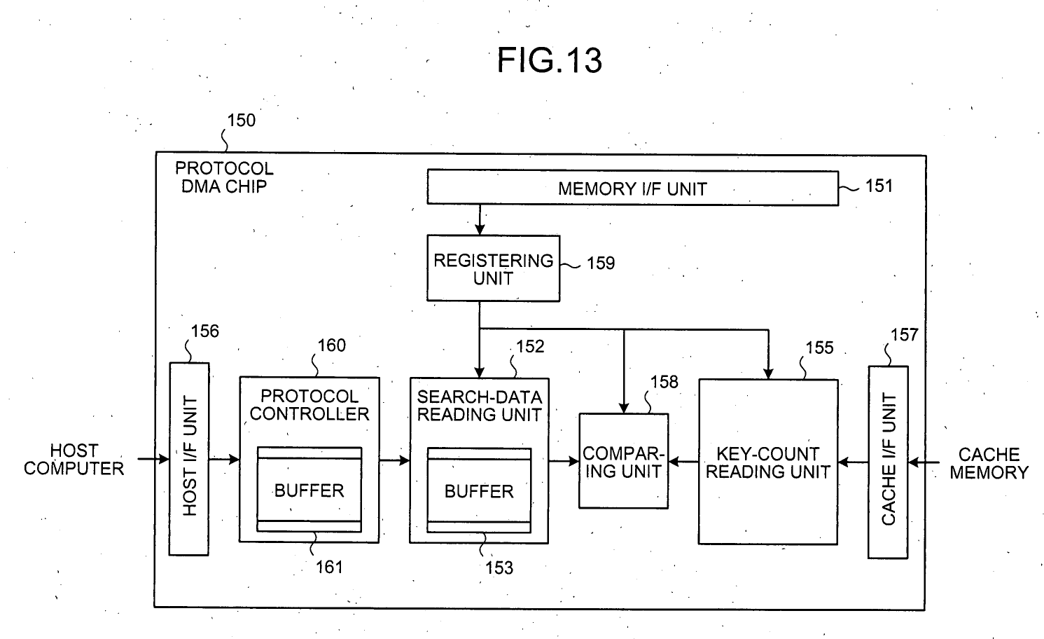

FIG. 10 is a block diagram of an example of a configuration of a protocol DMA chip according to the second embodiment. The same reference numerals are used for components in FIG. 10 that have the same function as the components of the DMA chip 10 according to the first embodiment shown in FIG. 4 and the corresponding descriptions are omitted.

The protocol DMA chip 50 includes the memory I/F unit 11, the descriptor control unit 14, the search-data reading unit 12, the cache I/F unit 17, a host I/F unit 51, a protocol control unit 52, a comparison unit 54, and a key-count reading unit 55.

The memory I/F unit 11 is connected to the descriptor control unit 14. The descriptor control unit 14 is connected to the search-data reading unit 12, the comparison unit 54, and the key-count reading unit 55. The descriptor control unit 14 receives instructions from the MPU 22, reads the descriptor stored in the memory 21, and transmits information in the descriptor to the search-data reading unit 12, the comparison unit 54, and the key-count reading unit 55. The host I/F unit 51 has a function of a communication I/F of transmitting and receiving data to and from the host computer 40A.

The protocol control unit 52 controls a protocol that is for communication with the host computer 40A. The protocol control unit 52 includes a buffer 53 that includes a static RAM (SRAM) and the like. The protocol control unit 52 is connected to the search-data reading unit 12 and the host I/F unit 51, and transmits the search data to the search-data reading unit 12 after storing the search data from the host I/F unit 51 in the buffer 53.

The search-data reading unit 12 is connected to the protocol control unit 52 by a predetermined bus (such as fiber bus). The search-data reading unit 12 includes the buffer (first buffer) 13, and transmits the search data to the comparison unit 54 after storing the search data in the buffer 13. In other words, the buffer 13 reads and stores temporarily the search data in the buffer 53, and when the search data stored temporarily is read by the comparison unit 54, reads the next search data from the buffer 53 and stores it temporarily.

The key-count reading unit 55 is connected to the cache I/F unit 17 by a predetermined bus (such as PCI bus). The key-count reading unit 55 includes a buffer (second buffer) 56. The key-count reading unit 55 receives search data (key unit or count unit) from the cache memory 31A via the cache I/F unit 17, stores the search data in the buffer 56, and then transmits the search data to the comparison unit 54. When the data stored in the buffer 56 is read by the comparison unit 54, the key-count reading unit 55 reads the next search data from the cache memory 31A and stores it in the buffer 56. In other words, the buffer 56 reads and stores temporarily the search data in the cache memory 31A, and when the search data stored temporarily is read by the comparison unit 54, reads the next search data from the cache memory and stores it temporarily.

The comparison unit 54 reads the search data stored by the buffer 13 of the search-data reading unit 12 and the search data stored by the buffer 56 of the key-count reading unit 55 and compares these search data.

According to the second embodiment, a transmission-speed of the bus that connects the search-data reading unit 12 and the protocol control unit 52 differs from a transmission speed of the bus that connects the key-count reading unit 55 and the cache I/F unit 17. The transmission-speed of the bus that connects the key-count reading unit 55 and the cache I/F unit 17 is faster than the transmission speed of the bus that connects the search-data reading unit 12 and the protocol control unit 52.

While performing the data search by instructions from the host computer 40A, reading the search data by the search-data reading unit 12 and reading the search data by the key-count reading unit 55 are started simultaneously. When the search data stored in the buffer 13 is read by the comparison unit 54, the search-data reading unit 12 reads the next search data and when the search data stored in the buffer 56 is read by the comparison unit 54, the key-count reading unit 55 reads the next search data. The comparison unit 54 reads the search data from the search-data reading unit 12 and the key-count reading unit 55, and compares these search data repeatedly.

An arrangement may be made such that the transmission-speed of the bus that connects the search-data reading unit 12 and the protocol control unit 52 is faster than the transmission-speed of the bus that connects the key-count reading unit 55 and the cache I/F unit 17.

According to the second embodiment, the configuration is made such that the protocol DMA chip 50 is provided with the descriptor control unit 14. However, the configuration may be made such that the protocol DMA chip 50 is provided with a registering unit (register block) instead of the descriptor control unit 14. In this case, every time the registering unit compares a set of the search data, the MPU 22 interrupts and information such as the memory address, the cache address, and the mode is transmitted from the MPU 22 to the DMA chip 10.

Thus, according to the second embodiment, since the key-count reading unit 55 includes the buffer 56, after the reading of the search data by the comparison unit 54 ends, even if the reading of the search data from the protocol control unit 52 to the search-data reading unit 12 is not completed, the key-count reading unit 55 can read the next search data from the cache memory 31A. In other words, the key-count reading unit 55 can read new search data before the search-data reading unit 12 reads the entire search data stored in the buffer 53 of the protocol control unit 52. This enables to read and transfer without reading and transferring of the bus with a high transmission-speed waiting for reading and transferring of the bus with a low transmission-speed, thereby enabling to transfer the data efficiently.

According to the present invention, it is not necessary to generate and transmit once each a plurality of information for searching stored data every time the data is compared. Therefore, it is possible to reduce a load during a data search. This enables to perform the data search rapidly and to transfer data efficiently.

Furthermore, according to the present invention, the stored data includes information about data length of comparison data and data length of a predetermined field in the stored data. This enables to perform the data search in detail.

Moreover, according to the present invention, stored data in a data storing memory is read from a cache memory that stores temporarily the stored data in the data storing memory. This enables to read the stored data rapidly.

Furthermore, according to the present invention, stored-data reading information includes a cache memory address of the stored data. This enables to search the stored data easily based on the cache memory address.

Moreover, according to the present invention, a buffer for storing temporarily the stored data in the data storing memory upon reading, is provided. This enables to read the next stored data after reading the stored data that is stored temporarily. Therefore, there is no need for reading of data by a bus with the high transmission speed to wait for reading of data by a bus with the low transmission speed. This enables to perform the data search rapidly and to transfer the data efficiently.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A data transferring apparatus that is connected to a data storing memory that stores a plurality of data as a plurality of stored data, the data transferring apparatus receiving comparison data to be compared with the stored data from an external unit, searching data corresponding to the comparison data from among the stored data, and transferring the stored data searched to the external unit, the data transferring apparatus comprising:
a control unit that controls the entire data transferring apparatus, and generates a plurality of pieces of comparison-condition information for searching predetermined stored data from the data storing memory;
a comparison-data storing unit that stores the comparison data received;
a comparison-condition storing unit that stores the comparison-condition information generated, upon the comparison-data storing unit storing the comparison data; and
a transfer processing unit that transfers the stored data searched to the external unit, the transfer processing unit including
an information extracting function of reading the comparison-condition information stored one by one, and extracting, from the comparison-condition information read, comparison-data reading information for reading the comparison data from the comparison-data storing unit and stored-data reading information for reading the stored data from the data storing memory;
a comparison-data reading function of reading the comparison data from the comparison-data storing unit based on the comparison-data reading information extracted;
a stored-data reading function of reading the stored data from the data storing memory based on the stored-data reading information extracted; and
a stored-data searching function of searching the stored data corresponding to the comparison-condition information and the comparison data by comparing the stored data read with the comparison data read based on the comparison-condition information.

2. The data transferring apparatus according to claim 1, wherein
each of the stored data is described in a variable-length data format that includes a predetermined data block for comparing with the comparison data, and
the comparison-condition information includes information related to a data length of the comparison data to be compared, and to a data length of a predetermined field in the stored data.

3. The data transferring apparatus according to claim 1, wherein
the data storing memory includes a cache memory that temporarily stores the stored data, and
the stored-data reading function is engaged with the transfer processing unit, and reads the stored data from the cache memory, based on the stored-data reading information.

4. The data transferring apparatus according to claim 1, wherein
the comparison-data reading information includes a comparison-data address related to an address at which the comparison data is stored in the comparison-data storing unit, and
the comparison-data reading function reads the comparison data from the comparison-data storing unit based on the comparison-data address.

5. The data transferring apparatus according to claim 3, wherein
the stored-data reading information includes a cache-memory address related to an address at which the stored data is stored in the cache memory, and
the stored-data reading function reads the stored data from the cache memory based on the cache-memory address.

6. A data transferring apparatus that is connected to a data storing memory that stores a plurality of data as a plurality of stored data, the data transferring apparatus receiving comparison data to be compared with the stored data from an external unit, searching data corresponding to the comparison data from among the stored data, and transferring the stored data searched to the external unit, the data transferring apparatus comprising:
a comparison-data storing unit that stores the comparison data received;
a control unit that controls the entire data transferring apparatus, and generates comparison-condition information for comparing the stored data with the comparison data;
a transfer processing unit that transfers the stored data searched to the external unit, the transfer processing unit including
a comparison-data reading function of reading the comparison data from the comparison-data storing unit based on the comparison-data reading information;
a stored-data reading function of reading the stored data from the data storing memory based on the comparison-condition information; and
a stored-data searching function of searching the stored data corresponding to the comparison-condition information and the comparison data by comparing the stored data read with the comparison data read based on the comparison-condition information, wherein
the comparison-data reading function includes a comparison-data storing buffer that reads the comparison data from the comparison-data storing unit, temporarily stores the comparison data read, and when the comparison data temporarily stored is read by the stored-data searching function, reads next comparison data from the comparison-data storing unit, and temporarily stores the next comparison data read, and
the stored-data reading function includes a stored-data storing buffer that reads the stored data from the stored-data storing unit, temporarily stores the stored data read, and when the stored data temporarily stored is read by the stored-data searching function, reads next stored data from the stored-data storing unit, and temporarily stores the next stored data read.

7. A data transferring method for a data transferring apparatus that is connected to a data storing memory that stores a plurality of data as a plurality of stored data, the data transferring apparatus receiving comparison data to be compared with the stored data from an external unit, searching data corresponding to the comparison data from among the stored data, and transferring the stored data searched to the external unit, the data transferring method comprising:
generating a plurality of pieces of comparison-condition information for searching predetermined stored data from the data storing memory;
storing the comparison data received in a first memory;
storing the comparison-condition information in a second memory upon the comparison data being stored in the first memory;
reading the comparison-condition information stored in the second memory one by one;
extracting comparison-data reading information for reading the comparison data from the first memory and stored-data reading information for reading the stored data from the data storing memory from the comparison-condition information;
reading the comparison data from the first memory based on the comparison-data reading information;
reading the stored data from the data storing memory based on the stored-data reading information;
searching the stored data corresponding to the comparison-condition information and the comparison data by comparing the stored data read with the comparison data read based on the comparison-condition information; and
transferring the stored data searched to the external unit.

8. The data transferring method according to claim 7, wherein
each of the stored data is described in a variable-length data format that includes a predetermined data block for comparing with the comparison data, and
the comparison-condition information includes information related to a data length of the comparison data to be compared, and to a data length of a predetermined field in the stored data.

9. The data transferring method according to claim 7, wherein the reading the stored data includes reading the stored data from a cache memory that temporarily stores the stored data, based on the stored-data reading information.

10. The data transferring method according to claim 7, wherein
the comparison-data reading information includes a comparison-data address related to an address at which the comparison data is stored, and
the reading the comparison data includes reading the comparison data from the first memory based on the comparison-data address.

11. The data transferring method according to claim 9, wherein
the stored-data reading information includes a cache-memory address related to an address at which the stored data is stored in the cache memory, and
the reading the stored data includes reading the stored data from the cache memory based on the cache-memory address.

12. A data transferring method for a data transferring apparatus that is connected to a data storing memory that stores a plurality of data as a plurality of stored data, the data transferring apparatus receiving comparison data to be compared with the stored data from an external unit, searching data corresponding to the comparison data from among the stored data, and transferring the stored data searched to the external unit, the data transferring method comprising:
storing the comparison data received in a comparison-data storing memory;
generating comparison-condition information for comparing the stored data with the comparison data;
reading the comparison data from a comparison-data memory based on the comparison-data reading information;
reading the stored data from the data storing memory based on the comparison-condition information;
searching the stored data corresponding to the comparison-condition information and the comparison data by comparing the stored data read with the comparison data read based on the comparison-condition information; and
transferring the stored data searched to the external unit, wherein
the reading the comparison-data includes
reading the comparison data from the comparison-data memory;
storing temporarily the comparison data read in a first buffer;
reading, when the comparison data temporarily stored is read, next comparison data from the comparison-data memory; and
storing temporarily the next comparison data read in the first buffer, and
the reading the stored data includes
reading the stored data from the stored-data memory;
storing temporarily the stored data read in a second buffer;
reading, when the stored data temporarily stored is read, next stored data from the stored-data memory; and
storing temporarily the next stored data read in the second buffer.
